(19) United States
(12) Patent Application Publication
(10) Pub. No.: US 2018/0116032 A1
(43) Pub. Date: Apr. 26, 2018

(54) Light Strip with Environmental Electrical Switches

(71) Applicants: Elmer A. Wessel, Lincoln, NE (US); Thomas P. Frederick, Lincoln, NE (US)

(72) Inventors: Elmer A. Wessel, Lincoln, NE (US); Thomas P. Frederick, Lincoln, NE (US)

(21) Appl. No.: 15/333,042

(22) Filed: Oct. 24, 2016

(51) Int. Cl. H05B 37/02; H05B 33/08; F21V 23/04; A47F 3/00

(52) U.S. Cl. CPC H05B 37/0227; H05B 33/0872; F21Y 2115/10; H05B 37/0218; A47F 3/001; F21V 23/0442

(57) ABSTRACT

A light strip may be fashioned from a plurality of environmentally controlled parallel light circuits positioned on a flexible, rigid or rigid-flexible circuit board. Each circuit may then be activated or deactivated discretely by triggering the appropriate environmental condition as to the preference and desire of the end user. Such light strips may then be easily deployed in multiple environments for the purpose of illumination.

### FIELD OF THE INVENTION

The present invention relates to the field of electrical switches and more particularly relates to a switch activated by environmental interaction and a strip of LED's individually controlled by a local switch such that the individual LEDs may be discretely activated and deactivated by a change in a user controlled environmental condition, such as the presence of a magnetic field.

### BACKGROUND OF THE INVENTION

Electric lighting has evolved from the simple novelty of the incandescent lamp to a tool that has become necessary in the functioning of today's society. As part of that evolution, specialty lights are being made to illuminate various areas which had not been illuminated before. These areas tend to be hard to reach or access and any lighting structure for these areas also tend to be specialized; therefore, accessible and easily activated lights are a desired improvement upon the art.

Environmental switches open or close based on ambient environmental conditions. These are ideal for situations where a user does not want or cannot engage in constant vigilance or when the user can control the environment for a short time frame to alter the ambient environment and trigger the switch. One type of environmental switch is a magnetic switch. The use of magnetic switches is known in the prior art. However, the most common magnetic switches are non-latching and revert to an original (open or closed) state when the magnetic field is removed. This fact alone can be troublesome in some applications as either a switch must be made to latch or the magnetic field must be maintained to keep the switch in a closed state.

Another need is the individual and discrete activation and deactivation of lighting sources. While individual light circuits may be activated from a centralized power source, such circuits tend to be heavily engineered both from hardware and software standpoints. A simpler device, with individual light control circuits in parallel, which control at most a few LEDs, may provide more targeted and manually controlled lighting with a lower cost. Being constructed of individual and discrete electrical circuits allows the system to be made into flexible, rigid, or rigid-flexible embodiments by providing a proper support substrate.

The present invention is a strip of light sources which are discretely activated by a user controlled environmental conditions, such as by a magnetic switch. Such light sources may include LEDs, Incandescent lamps, fluorescent lamps. The strip is utilizable in many settings where lighting is desirable, including but not limited to shelving and merchandizing racks.

The present invention represents a departure from the prior art in that the light strip of the present invention allows for manually triggered environmental activation and deactivation of parallel, discrete, and targeted lighting control circuits for lighting purposes.

### SUMMARY OF THE INVENTION

In view of the foregoing disadvantages inherent in the known types of lighting structures, this invention provides a convenient light source which is adaptable to multiple environments. As such, the present invention's general purpose is to provide a new and improved light strip that is easily manufactured, has easily activated and deactivated switches, and is easily deployable in many scenarios.

To accomplish these objectives, a preferred embodiment of a strip may be divided into individual parallel circuits which have at least one light source, like an LED, and at least one switch. When an environmental condition is met, such as being in the presence of an appropriate magnetic field, the at least one switch closes or shifts from one circuit (off) to another (on), allowing the at least one LED to activate. A counter magnetic field could then open the at least one switch and deactivate the at least one light source. Ideally, the presence of a stronger than ambient magnetic field, or other abnormal environmental condition, should be required to open or close the switch. In this manner, the switch maintains its on or off condition when the normal ambient condition is restored. By maintaining a plurality of circuits in series, light sources such as individual LEDs or groups of LEDs may be specifically targeted for activation and deactivation by a user initiated change in the ambient environmental condition

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention

### BRIEF DESCRIPTION OF THE DRAWINGS

FIG. 1 is a diagram showing a basic circuit which could serve as a light circuit for use with a light strip.

FIG. 2 is an alternate circuit which could similarly serve as a light circuit for use with a light strip.

FIG. 3 is a schematic layout of the components in the basic circuit of FIG. 1.

FIGS. 4A, 4B, 4C and 4D are successive perspective views of a store merchandiser with a magnetically actuated lighting strip installed, showing operation.

FIG. 5 is a block diagram for an alternate embodiment of a switch paradigm for use with RGB LEDs.

FIG. 6 is a block diagram for an alternate embodiment utilizing a dimming feature.

FIG. 7 is a block diagram for a second alternate embodiment utilizing a dimming feature.

FIG. 8 is a block diagram for an alternate embodiment for affecting a change in some characteristic in a light strip with LEDs.

FIG. 9 is a block diagram for an alternate embodiment utilizing two different environmental switches for controlling different characteristics of the light strip.

### DETAILED DESCRIPTION OF THE PREFERRED EMBODIMENT

With reference now to the drawings, basic and preferred embodiments of an environmentally controlled light strip are herein described. It should be noted that the articles “a”, “an”, and “the”, as used in this specification, include plural referents unless the content clearly dictates otherwise.

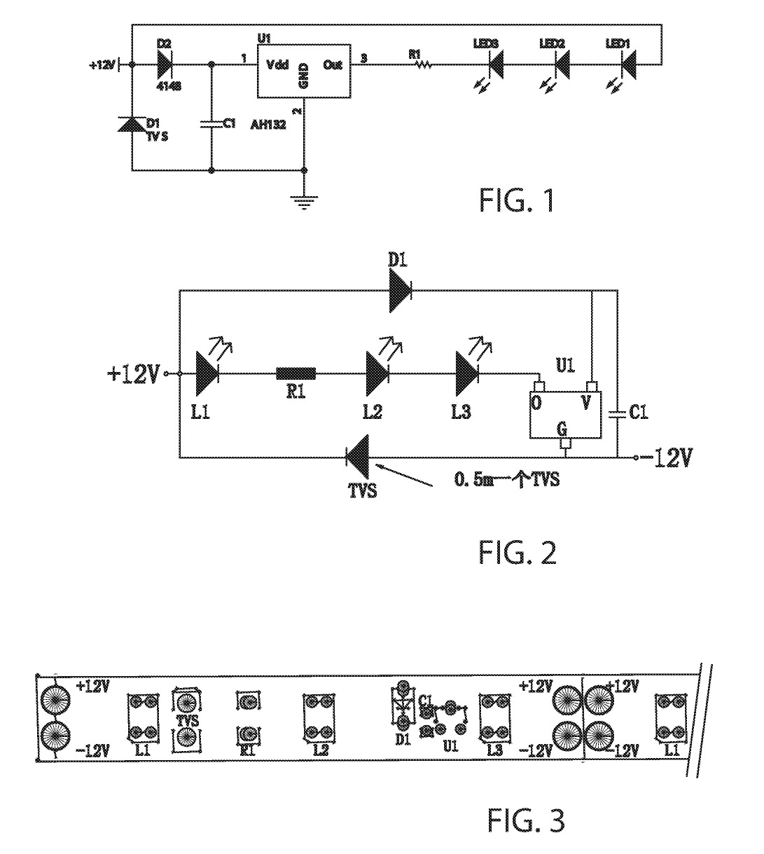

With reference to FIG. 1, a simple circuit that could be used with the invention would have an electrical source+12V pass into an input Vdd of the switch U1. The depicted switch U1 is field effect transistor which will route the electrical power into the LED loads (LED1, LED2, LED3) when active. Other components of the circuit may be utilized as necessary to the system, such as the switching diode D2, capacitor C1, resistor R1, and transient voltage suppressor (TVS) D1. In the illustrated embodiment, the switch U1 activates on the application of an appropriate magnetic field (condition 1) and it remains active until a counter magnetic field (condition 2) is applied. In this manner, ambient environmental conditions during normal operation need not affect the status of the switch U1 and a discrete number of LED loads may be powered by a single, inexpensive switch.

Circuits such as the one depicted in FIG. 1, and other similar circuits like the one depicted in FIG. 2, may then be placed in parallel along a light strip, as shown in FIG. 3. Each circuit should control a discrete length of the light strip—ideally 1 to 4 inches in length with today's components. The light strip may be a circuit board, including rigid, flexible and rigid-flexible circuit boards, holding the components with electrical tracing making the requisite connections. Other structures to support and complete the circuitry other than a circuit board are possible whether now known or later conceived in the art. The individual circuit sections may be made as large or as small as physical constraints of the components allow. By placing the circuits in parallel and balancing the threshold conditions for a switch to change electrical states with a given means of changing the environmental condition, such as with a specific magnet of a set strength, individual and discrete sections of LEDs may be activated or deactivated at the will of the end user.

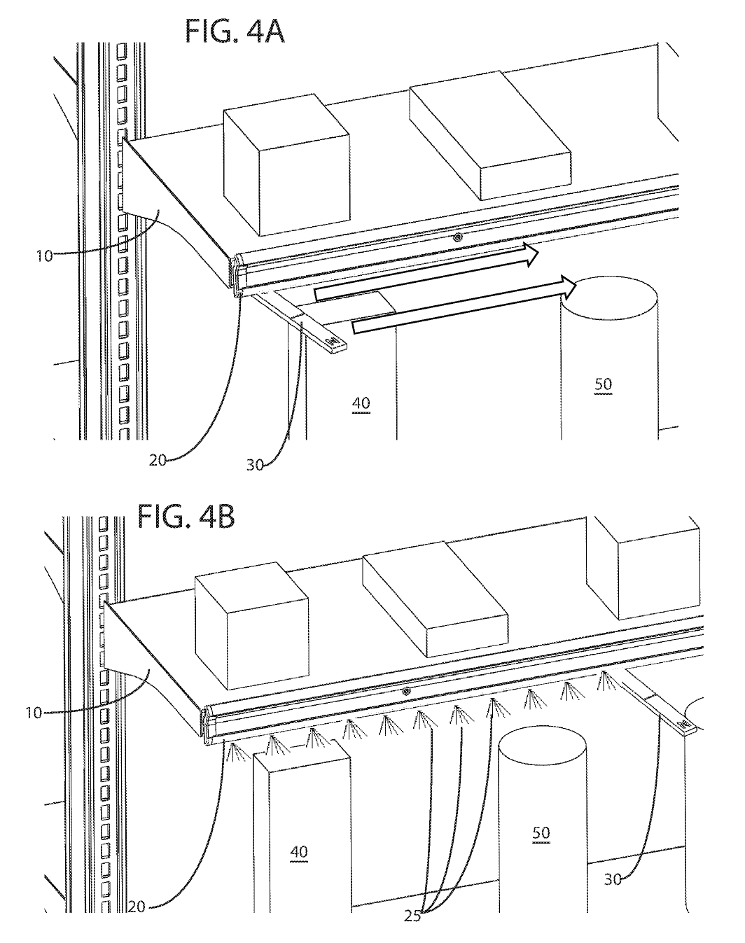

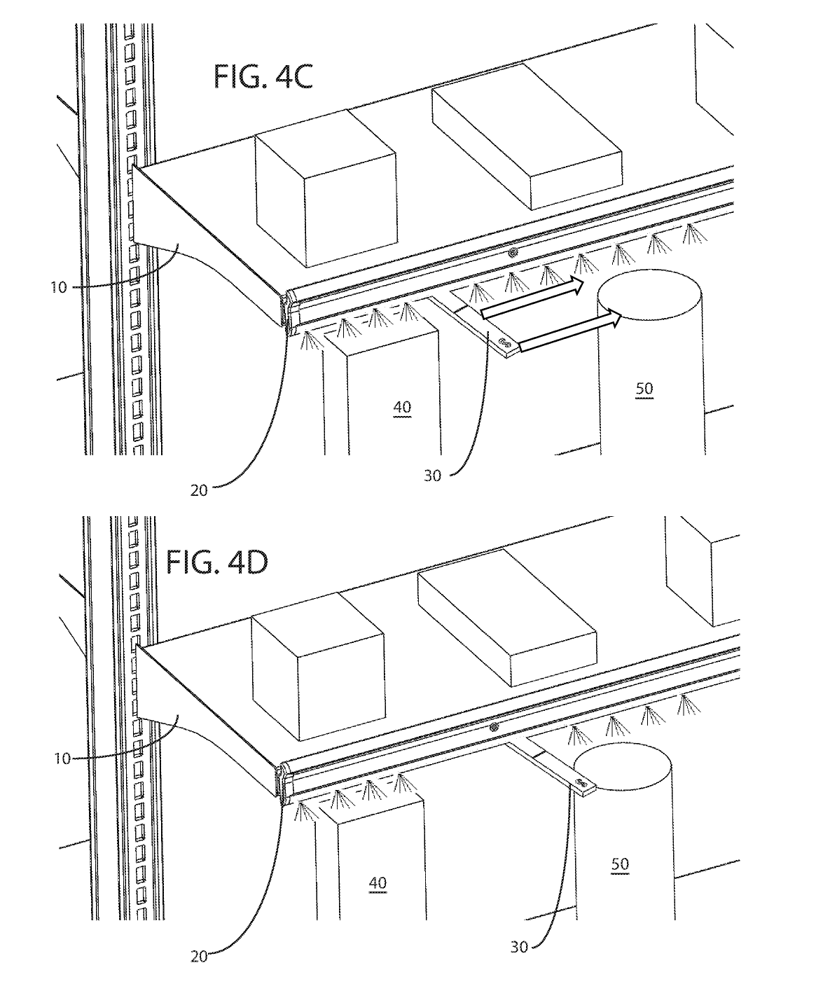

The light strips may then be utilized in many different applications. One of the most interesting is use in merchandizing displays. Product 40, 50 on a merchandiser may be illuminated by a light strip hidden in the merchandiser structure 10, as is shown in FIGS. 4A-4D. In the illustrated example, a magnetic switch is utilized so that specific illumination of targeted products may be accomplished by the application of an appropriate magnetic field (generated by magnet 30) proximate the hidden light strip in price channel 20. In this manner, individual lighting circuits on the light strip for a determined length of the merchandiser shelf may be illuminated, while neighboring lighting circuits may be left deactivated or, if desired, may then be independently deactivated. As seen in FIG. 4A, a merchandiser with a given shelf holding product 40, 50 is provided. A magnet 30 is then slid along the price channel 20, where the light strip in this example is hidden, in an area proximate product 40, 50. This activates all of the individual control circuits and associated lights 25 for the length over which the magnet was slid (FIG. 4B). If a given area is not desired to be lit, such as between products 40 and 50, the magnetic field is reversed and magnet 30 is slid along a subsection of the lit area (FIG. 4C). Application of an opposite magnetic field deactivates the individual switches (FIG. 4D). Proper balancing of the magnet's strength and switch threshold allows a physical correspondence with magnet 30 position and the activated/deactivated switches and associated LEDs 25. This targeted aspect of the invention is not seen without more complex control circuitry or electronic mapping to achieve the same effect.

It is to be readily understood that circuit design choices as to type of components, type of light sources, number and types of LEDs, power considerations, and physical dimensions are all determined by the designer and many variations of these considerations still fall within the purview of the invention. Likewise, a switch driven by other environmental factors other than magnetic field, such as but not limited to temperature, ambient light, barometric pressure, and relative humidity, may be designed and still fall in the purview of the invention. Likewise, combinations of two or more different environmental conditions may be utilized to affect different aspects of a control circuit for different lighting effects. The switch may also be designed to either reset or to maintain its last electrical state in the event of a power failure.

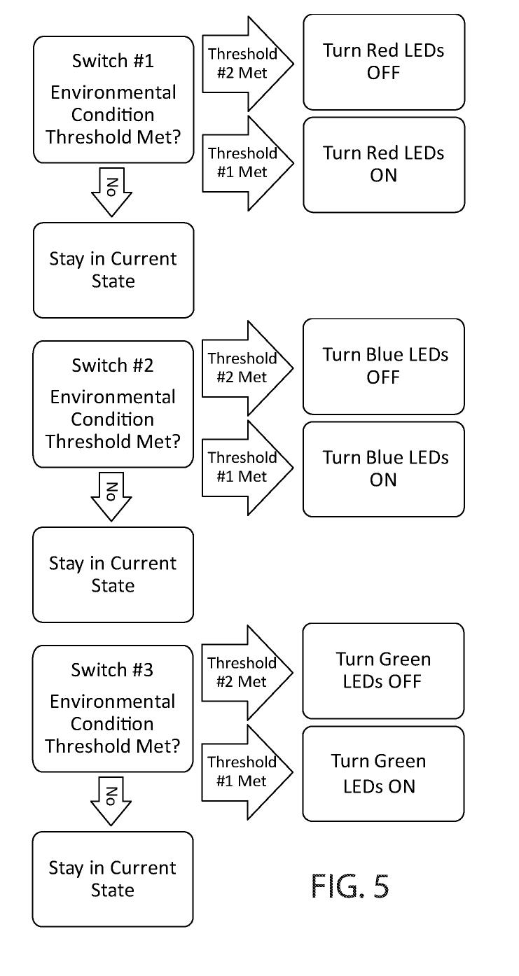

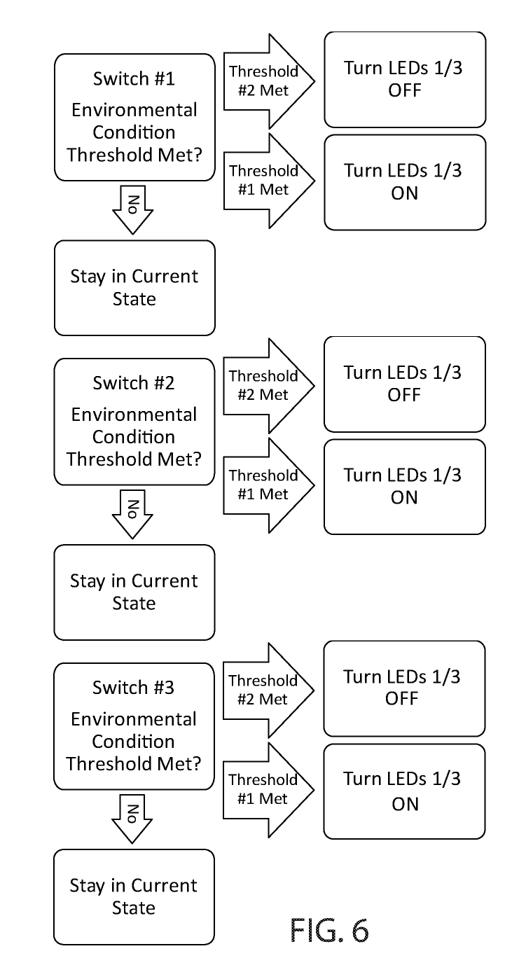

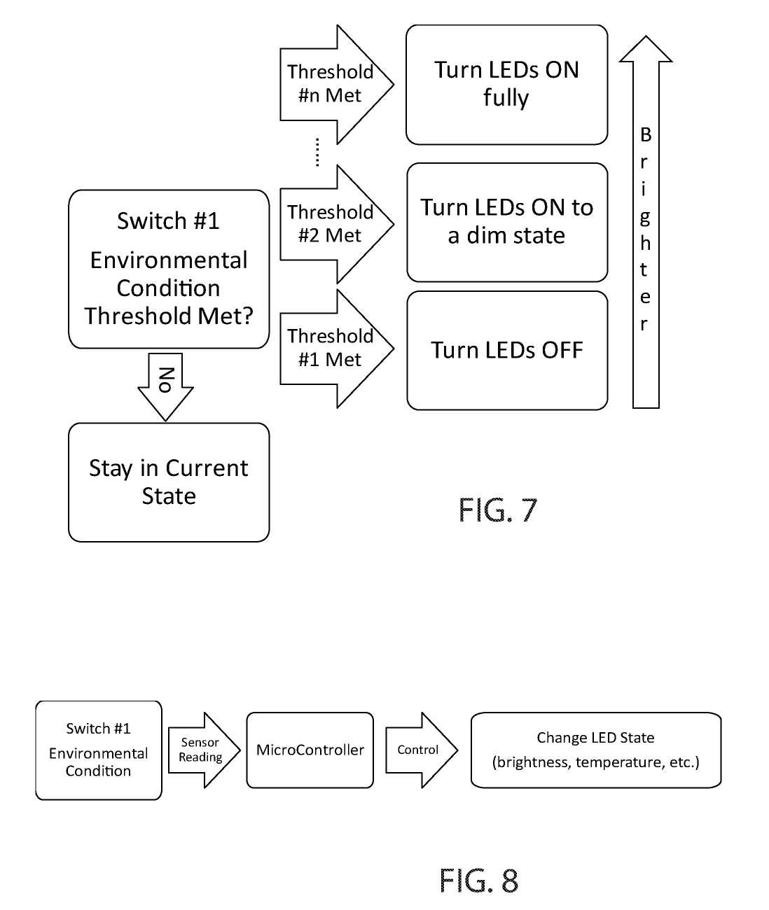

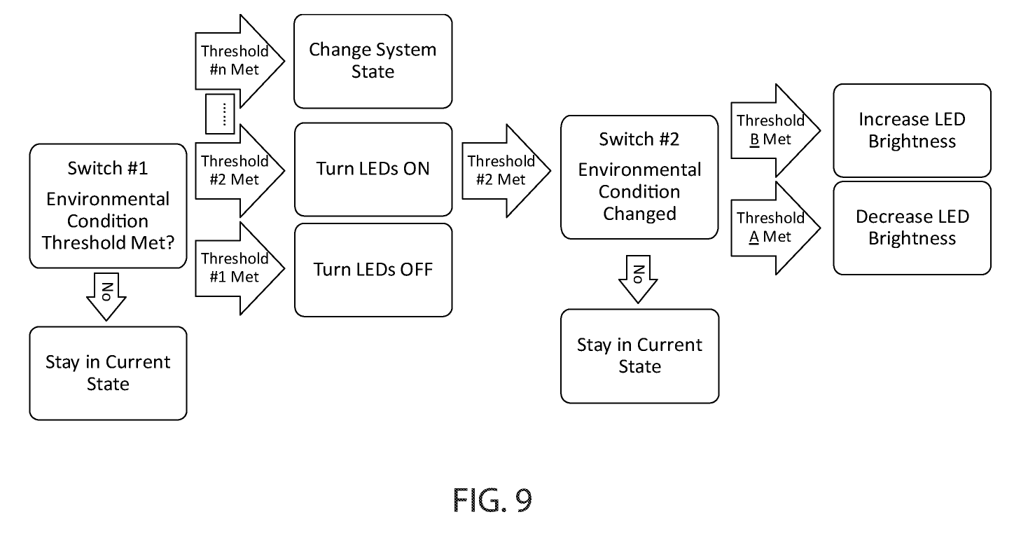

Other exemplary embodiments are shown in FIGS. 5-9. In FIG. 5, three switches, each with unique thresholds, may be used to control an RGB LED or a plurality of Red, Green and Blue LEDs. The environmental conditions may be based upon the same type of condition (i.e. strength of magnetic field), time during which the environmental condition is present, or may be controlled by a successive application of the environmental condition. Likewise, each switch may be located separately from each other such that an environmental change for one switch would not register as an environmental change for other switches. In this manner, one, two or all three colors may be activated or deactivated, providing different colored effect. Likewise, in FIG. 6, the brightness of each individual light circuit in the strip may be controlled, in this case by controlling the current flowing thought the circuit. Changing the brightness of the light circuits based on successive changes in the environmental condition is shown in FIG. 7. The addition of a microcontroller may allow for greater flexibility in controlling the light circuits and/or entire light strip. Sensors in this case could include RFID, NFC or Bluetooth communication transmitters and receivers which could receive commands from a separate application, such as a phone app. The microcontroller may then control almost any aspect of the lights, including brightness and color temperature. Using two different environmental conditions is also conceivable, and is illustrated in FIG. 9. In FIG. 9, a magnetic field sensor controls the basic on/off state of the switch, but an ambient light sensor then controls the brightness of the lights after activation.

Given the numerous permutations possible to create different embodiments of the invention, it is important to not see the above exemplary embodiments as limiting. Numerous modifications and variations can be made and still the result will come within the scope of the invention. No limitation with respect to the specific embodiments disclosed herein is intended or should be inferred.

What is claimed is:

1. A light strip comprising:
a. a component mounting and connection structure; and
b. a plurality of parallel lighting circuits mounted upon the component mounting and connection structure, said parallel lighting circuits each further comprising:
i. at least one switch that will change electrical states upon a specified change in a first environmental condition reaching a given first threshold; and
ii. at least one light source;
wherein, the environmental condition is one intentionally altered in an effort to change the electrical state of the at least one switch.

2. The light strip of claim 1, the component mounting and connection structure being selected from a set of circuit boards consisting of: flexible boards, rigid boards, rigid-flexible boards.

3. The light strip of claim 1, the environmental condition being the presence of a first magnetic field.

4. The light strip of claim 3, the presence of a second, alternate, magnetic field also causing a change in the electrical state of the at least one switch.

5. The light strip of claim 4, the threshold change in environmental condition being balanced with a given magnet having a magnetic field such that the presence of the magnet may alter the electrical state of one switch at a time.

6. The light strip of claim 1, the at least one light source being selected from the set of light sources consisting of: LEDs, incandescent lamps, and fluorescent lamps.

7. The light strip of claim 1, the at least one light source being at least one RGB LED and the at least one switch being three switches, each switch being operatively coupled to one color section of the at least one RGB LED and each switch also having a set environmental threshold in a manner to control individual color sections of the at least one RGB LED.

8. The light strip of claim 1, each lighting circuit further comprising at least a second environmental switch.

9. The light strip of claim 8, the second environmental switch being actuated by a second environmental condition, unrelated to the first environmental condition, upon reaching a given second threshold.

10. The light strip of claim 9, the first environmental condition being the presence of a magnetic field and the second environmental condition being intensity of ambient light.

11. A light strip comprising:
a. a component mounting and connection structure; and
b. a plurality of parallel lighting circuits mounted upon the component mounting and connection structure, said parallel lighting circuits each further comprising:
i. at least one environmental sensor keyed to a first environmental condition
ii. a microcontroller to control electrical states of the parallel lighting circuit of which the microcontroller is a part; and
iii. at least one light source;
wherein, the microcontroller alters only the electrical state of its parallel lighting circuit based upon readings from the at least one environmental sensor and the environmental condition is one intentionally altered in an effort to change the electrical state of at least one parallel circuit.

12. The light strip of claim 11, the component mounting and connection structure being selected from a set of circuit boards consisting of: flexible boards, rigid boards, rigid-flexible boards.

13. The light strip of claim 11, the environmental condition being the presence of a first magnetic field.

14. The light strip of claim 13, the presence of a second, alternate, magnetic field also causing the microcontroller to alter the electrical state of the at least one parallel circuit.

15. The light strip of claim 14, the threshold change in environmental condition being balanced with a given magnet having a magnetic field such that the presence of the magnet may cause the microcontroller to alter the electrical state of at least one light source at a time.

16. The light strip of claim 11, the at least one light source being selected from the set of light sources consisting of: LEDs, incandescent lamps, and fluorescent lamps.

17. The light strip of claim 11, the at least one light source being at least one RGB LED and the at least one microcontroller being operatively coupled to each color section of the at least one RGB LED in a manner to control individual color sections of the at least one RGB LED.

18. The light strip of claim 11, each lighting circuit further comprising at least a second environmental sensor detecting a second environmental condition.

19. The light strip of claim 18, the second environmental condition being unrelated to the first environmental condition.

20. The light strip of claim 19, the first environmental condition being the presence of a magnetic field and the second environmental condition being intensity of ambient light.
